(19) United States
(12) Patent Application Publication
(10) Pub. No.: US 2008/0154690 A1
(43) Pub. Date: Jun. 26, 2008

(54) METHOD AND SYSTEM FOR MANAGING AN INTEGRATED WORKLIST

(76) Inventor: Lionel Mommeja, La Gaude (FR)

Correspondence Address: HOFFMAN, WARNICK & D'ALESSANDRO LLC, 75 STATE ST, 14 FL, ALBANY, NY, 12207, US

(21) Appl. No.: 11/943,075

(22) Filed: Nov. 20, 2007

(30) Foreign Application Priority Data
Dec. 21, 2006 (EP) 06301286.8

(51) Int. Cl. G06F 17/30; G06F 3/048; G06Q 99/00

(52) U.S. Cl. 705/9

(57) ABSTRACT

A method, computer program and system for managing from a portal the worklists of server applications, each of the server applications owning one of the worklists and having at least one portlet on the portal. When a user connects to the portal, a server application worklist portlet, one for each server application, sends the corresponding user worklist content and preferences to an integrated worklist portlet. The integrated worklist portlet, displays to the user a view of a worklist integrating the worklists of all the server applications. Any change with a task is detected by the server application worklist portlet and sent to the integrated worklist portlet for refreshing the view of the integrated worklist.

### FIELD OF THE INVENTION

The present invention generally relates to development of User Interfaces and, more particularly, to a method and system for managing an integrated worklist.

### BACKGROUND OF THE INVENTION

Today, employees working in enterprises have to interact daily with many applications running on their desktop.

A worklist is defined as a list of work items. A work item is defined as a task an employee has to work on within a specific workgroup productivity software. This concept of worklist exists in many commercially available workgroup productivity software, such as IBM Lotus Notes, IBM WebSphere, IBM WebSphere MQ Workflow, etc. (Lotus Notes and WebSphere are trademarks of International Business Machines Corporation in certain countries). Worklists and work items are specific to each application. Work items are objects representing the tasks forming the worklist content.

Managing several work items coming from several applications requires end-users to:

### 1. Build manually (typically mentally) an aggregate view of all the work items, coming from the various applications that are part of the working environment, that need to be performed by the end-user;

### 2. Assign a priority among all these work items;

### 3. Schedule the execution of these work items; and

4. Work on the work item: claim/execute/complete/unclaim/ . . . , a work item. At the time being, there is, in the state-of-the-art, no end-user metaphor nor front-end integration mechanism that helps end-users managing work items coming from various applications. This is especially true for steps 1, 2 and 3 above.

Some solutions to this problem of integration exist, but are not really supporting all the features one can expect from a true integrated worklist. The most known solution to this problem is to use an e-mail system: each time a new work item is created by an application, a new e-mail is sent to the end-user. When the user opens the corresponding e-mail there is typically an hyperlink that directs him/her to the related application. The user can then work on the work item. By using this well-known mechanism, the end-user has the guaranty that the work items coming from all the applications are visible and accessible from one integrated access point: the e-mail box.

However, this simple solution has several disadvantages and is far from solving all the problems listed above:

1. Work items are not presented in a consistent way in the e-mail box. For example, each application uses its own style for the e-mails representing work items. It is then difficult for the user to have, at a glance, a consistent view of all the work items to work upon. In addition, the e-mail representing the work items are often mixed with other e-mails that have obviously nothing to see with application-related work items

### 2. As there is no consistent data model for the e-mails representing the work items, it is not possible to manage them in a consistent way (e.g.,: sorting by priority, time, type, etc.).

3. E-mails representing work items are e-mail and not work items (a mail box is not a worklist). For example, a work item that is canceled (e.g., by an administrator), or claimed by an other user, is still present in the mail box via its corresponding e-mail.

Another design alternative would be to use a workflow engine playing the role of a proxy integrating with all the other applications. The workflow engine's worklist would then present a consolidated view of each application's worklist. While this solution can present some functional advantages, it may be merely “over-design” and very costly to implement in many situations.

Another approach is to leverage the emerging portal technology: in order to improve employee's user-experience and productivity, and to decrease information technology costs, more and more enterprises are deploying corporate portals, which allow to integrate visually these various applications into a single consistent, secured and user-friendly access point. An end-user connecting to his enterprise portal will typically navigate among several portlets to view and work with all the work items that are awaiting for processing.

While a corporate portal can greatly improve employee productivity due to its front-end integration capabilities, there is still a need for integration of worklists. A solution such as a SAP unified worklist is a possible solution on several aspects in term of functionality. A unified worklist is an application to be installed accessible through a portal. A unified worklist application communicates directly with the applications located on the server side using a connector. This architecture imposes strong coupling between the unified worklist application and the applications located on the server side. Consequently, adding a new application located on the server side implies changes in the unified worklist environment to be able to include the worklist of this new or modified application. Even if the unified worklist solution is satisfying for the worklist management functions, nevertheless, this solution has also several drawbacks:

a. Deploying a new application or a new version of an existing application, would imply to deploy or re-deploy both the application portlets and the integration code within the unified worklist execution environment; and
b. The solution cannot run on another portal, for example, IBM WebSphere Portal.

As a consequence, even if with this latter solution is functionally satisfying from a user's perspective, several drawbacks remain which cannot be overcome on the basis of such an architecture. There is thus still a need for a portal-based integrated, vendor neutral, worklist solution which reduces the deployment effort each time a new application is created or an existing application is modified.

### SUMMARY OF THE INVENTION

The present invention provides a method for federating in one interface all the tasks of the different applications a user works with. Further, the present invention provides a portal based solution which is portable to any type of portal and which can be installed and which requires a minimum of changes for managing the worklist of a new application or of a new version of an existing application.

An aspect of the invention is directed to a method for managing from a portal, worklists of more than one server application, each of the server applications owning one of the worklists and having at least one portlet on the portal, comprising: a portal user connects to the portal with an identifier; a worklist portlet for each server application reads the user identifier and displays to the user a corresponding user worklist content and preferences to an integrated worklist portlet; the integrated worklist portlet, using a graphical user interface, reads the user worklist content and preferences for each server application and builds and displays to the user a view of an integrated worklist integrating the worklists of all the server applications.

The invention provides a unique graphical user interface for viewing all the tasks to be accomplished from all the applications the user works with. With a use of a portal, the developer can not only provide a graphical visualization of the list of tasks but also provide additional functionalities such as task a priority management or setup of timers and warnings which use the ability of development under a portal. The flexibility of development of a portal, the developer can provide adapt the display characteristics, for instance, to the specificity of an enterprise. Further, the development cost is limited for the enterprises having already developed a portal in comparison with the development of a brand new application.

The integrated worklist environment comprises a standard portlet application defined with JSR168 specification instead of proprietary code portlet. This allows portability of the integrated worklist environment on any other standardized portal. The support for integrated worklists comprises exchanges of information between the integrated worklist portlet application and both the application portlets and their respective “worklets” (the term worklet is for “worklist portlet”, which is described in greater detail below). As the Integrated worklist portlet application uses the inter-portlet communication protocol standardized in JSR168, this reinforces portability and allows seamless integration of any new or modified portlet application for which the worklist is integrated. With the architecture proposed, each time a new application is created or an existing application is modified there is no need to modify the existing Integrated worklist environment to recognize the changes and integrate the new or modified application. The run time deployment of the new or modified application, only requires steps related to the deployment of the application itself, no specific step is to be executed in relation with the integration of the corresponding worklist.

### BRIEF DESCRIPTION OF THE DRAWINGS

Embodiments of the present invention will now be described by way of example with reference to the accompanying drawings, in which like references denote similar elements.

FIG. 1 shows the components to be added to a portal environment for managing an integrated worklist for more than one application according to an embodiment of the present invention.

FIG. 2 is a view of the graphical user interface of an integrated worklist portlet application according to an embodiment of the present invention.

FIG. 3 is a flowchart of user interactions for working with a specific task from an integrated worklist according to an embodiment of the present invention.

FIG. 4 is a flow chart describing the refreshing of an integrated worklist to reflect a change in one task of the applications.

FIG. 5 is a flowchart describing the creation of an environment for managing an Integrated worklist on a portal according to an embodiment of the present invention.

### DETAILED DESCRIPTION OF THE INVENTION

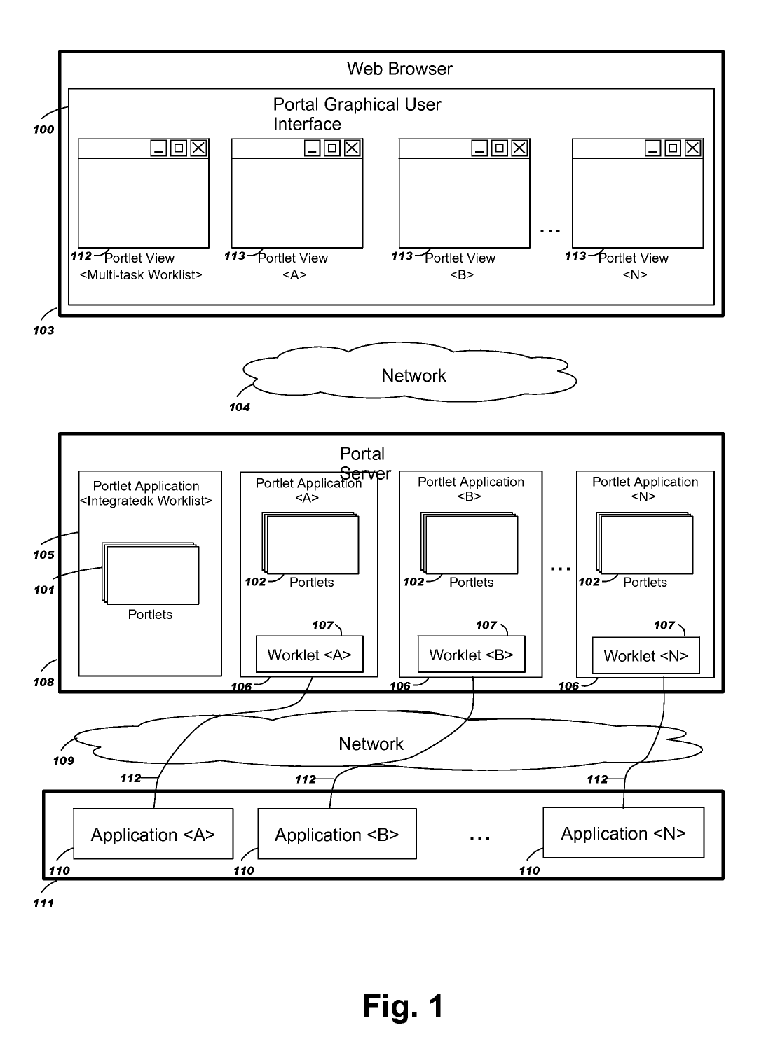

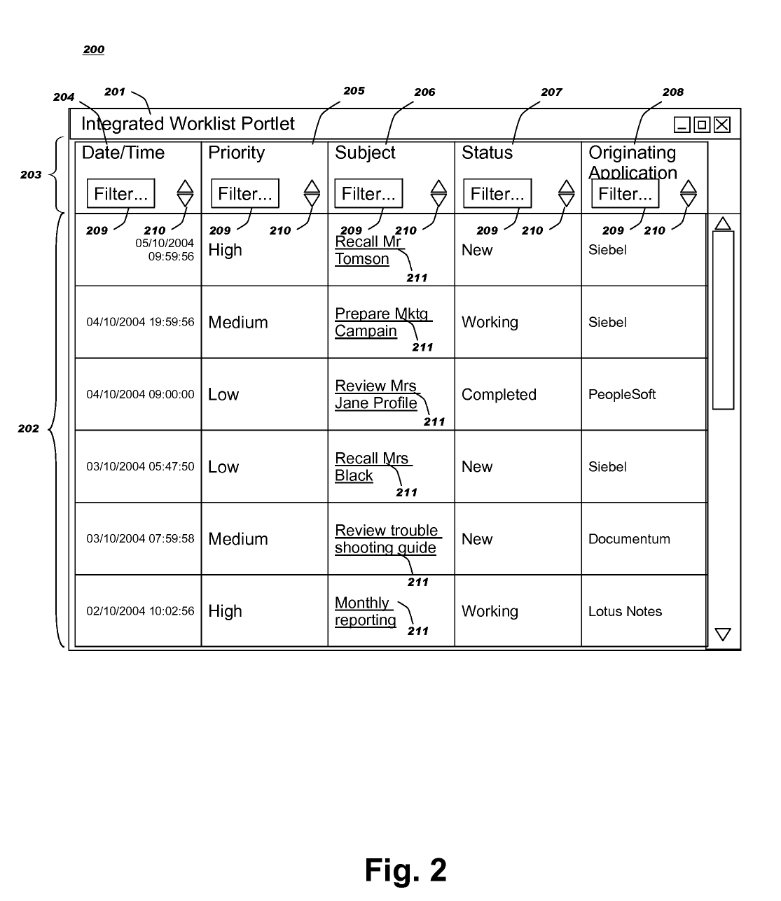

The architecture of an embodiment of the present invention is described in FIG. 1. The architecture is a multi-tiered architecture which comprises a web browser tier 103, which is the user side portal, connected through a network 104 to a portal server tier 108, which is the server side portal, and an application tier 111 connected to the server side portal through a network 109. The web browser tier 103 represents the software layer allowing all the possible accesses by devices to the network 104 (such as the Internet) to the portal server tier 108. Examples of devices are a PC, a SmartPhone, or a voice server. Example of software layers are Internet browsers or any equivalent application. The web browser tier 103 is displaying the portal's graphical user interface 100 which contains several portlets views 112, 113. The portlet views 112, 113 are a rendering of the portlets 101, 102 deployed in the portal server tier 108. The rendering mechanism can be implemented with protocols such as HTML, HTTP, XML, JavaScript, etc. Portlet views 113 contain the user interface of the applications 110. Although they play a role, portlet views 113 are not necessarily specific to the present invention. Portlet view 112, which is specific to the present invention, contains a rendering of the integrated worklist portlets 101. An embodiment for this rendering is described below in relation with FIG. 2.

The portal tier 108 represents a portal server. A set of portlet applications 105, 106 are deployed on the portal server 108. A portlet application 105, 106 is a web application containing portlets and a portlet deployment descriptor in addition to servlets, JSPs, HTML pages, classes and other resources normally found in a web application. Although they play a role, portlets 102 are not necessarily specific to the present invention. However, these portlets 102 could be optimized for an even better implementation of the present invention. Portlets 101 are specific to the present invention, and implement the logic and the configuration data which is generic to the Integrated worklist. The worklets 107 are running in the scope of a portlet application 106. Worklets 107 implement the necessary adaptation logic between the applications 110 and the integrated worklist portlet application 105. Worklets 107 are typically implemented in a language such as Java. The communication between the integrated worklist application 105 and the worklets 107 is achieved with communication protocols such as IIOP (IIOP is a trademark of the Object Management Group) or JMS. The communication between the worklets 107 and the applications 110 is implemented with enterprise application integration protocols (such as IIOP, JMS, Web Services) via application-specific adapters 112 and a network 109. An example of commercial adapter packages is IBM WebSphere Business Integration Adapter for Siebel/SAP/PeopleSoft. An example of a standard adapter protocol is Sun's Java Connector Architecture. Adapters allows a two-way communication between the portal server and the applications.

In an other embodiment, a worklet 107 could be fully implemented within an enterprise application integration middleware allowing a hub-and-spoke or bus architecture (a commercial product such as IBM WebSphere Business Integration InterChange Server implements this feature).

The application tier 111 represents the set of applications 110 which are integrated in the portal presented to the user. Each application 110 contains its specific worklist management logic. One purpose of the worklets 107 is to adapt the application-specific worklist management logic to the generic worklist management logic implemented in the integrated worklist.

FIG. 2 illustrates a web page 200 and more precisely a portion of a web page of an integrated worklist portlet 101 according to an embodiment of the present invention. The content of this portlet main page illustrates the graphical user interface of the Integrated worklist user. The portlet's content depends on the portlet's user profile. This profile may be loaded at logon time.

A banner area 201 may be used to display the title of the portlet as well as some iconic representation of some function that can be performed on the portlet itself (such as minimize, maximize, close).

The portlet contains an integrated list of tasks 202, coming from various applications, which can be performed by the user of the portlet. This list is made of several columns. Each column has a header section 203 which may include a title (such as “Date/Time”, “Priority”, “Subject”) and an interaction metaphor that gives access to a filter function 209 and a sort function 210. The filter function 209 allows the display of a subset of the tasks. The sort function 210 allows the sorting of the elements of the list according to a criteria (such as most recent task to least recent task, or alphabetic order).

A “date and time” column 204 is provided to allow the user to select a task to work with according to a time criteria. For example, the user may want start working with the oldest task and then up to the most recent one.

A “priority” column 205 is provided to allow the user to select a task to work with according to a priority criteria. For example, the user may want to work with the most urgent tasks.

A “subject” column 206 is provided to allow the user to select a task given its name. For example, the user may want to work first with all the tasks related to marketing campaigns. The portlet gives a way to navigate from a representation of the task in the task list to the application interface which allows to actually work on the task. A possible embodiment of this user interaction is to highlight the subject name as an hyperlink. When the user clicks on this link 211, the control is passed to the portlet associated to the target application.

A “status” column 207 is provided to allow the user to select a task according to its status. For example, the user may want to work first with the tasks which status is “new”.

An “originating application” column 208 is provided to allow the user to select a task according to its originating application. For example, the user may want to work with the tasks originated from “Siebel”.

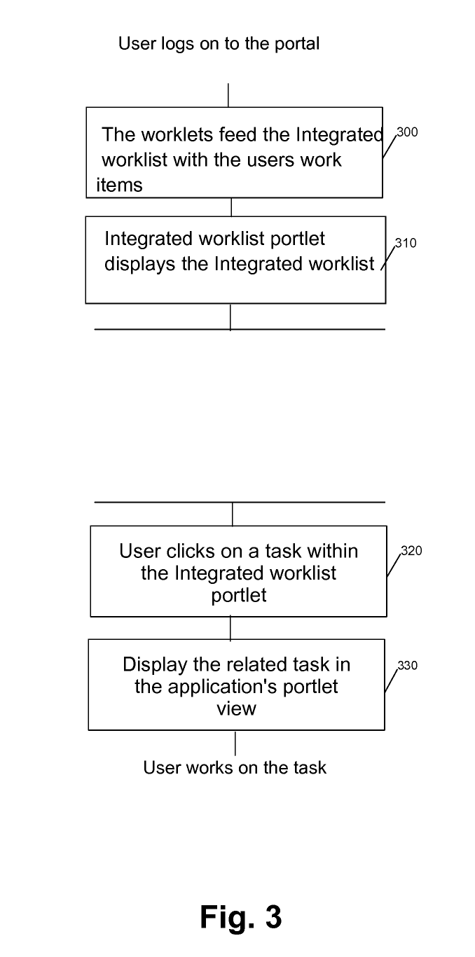

FIG. 3 describes a way to navigate from the integrated worklist portlet to the portlets hosting the tasks to execute. Before (300): User logs on the portal with his/her own credentials. The portal returns user identity. At (300), with user identity as input, the integrated worklist portlet view content is fetched from the integrated worklist data model. The integrated worklist portlet is ready for use

At (301), the user clicks on a task in order to work with it. FIG. 2 describes an embodiment of this interaction: when the user clicks on the hyper-link 211 the control is passed to the portlet hosting the task's user-interface (302). An embodiment of this mechanism can be based on Sun JSR168 Portlet Application Programming Interface PortletURL interface:

### A) User clicks on hyper-link 211;

### B) The integrated worklist portlet gathers the task parameters (task id, target application portlet view name); and

### C) The integrated worklist portlet invokes the PortletURL interface of the target application portlet

### EXAMPLE

...
PortletURL targetApplicationPortletUrl = response.createActionURL( );
url.addParameter(“Service Request”,”SR456721”);
url.setWindowState(WindowState.MAXIMIZED);
writer.print(“<FORM METHOD=\”POST\” ACTION=\””+
url.toString( )+”\”>”);
...

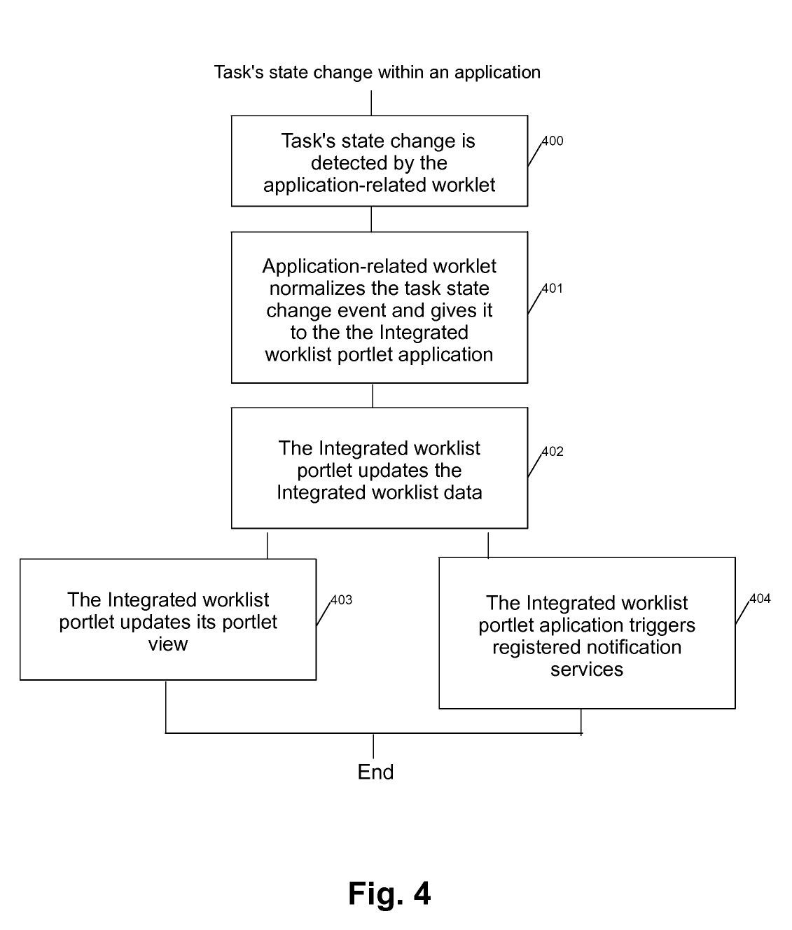

FIG. 4 describes an embodiment for the content update of an integrated worklist portlet. The integrated worklist portlet content is updated as soon as a task is updated. A task update is in general related to a change in its life-cycle (such as transition from “new” to “in progress”).

A user cannot directly affect the life-cycle of the tasks within the integrated worklist portlet itself, although in another embodiment of the present invention, a user could implement it. The overall principle is that task changes are always performed within the applications 110 themselves. This change can be done either via the portlet application 106 or via the genuine application user interface (such as a dedicated web-based interface or a rich client interface).

At (400), the task's state change is detected by the application-related worklet. The application adapter 112 is configured to detect task changes (for example IBM WebSphere Business Integration Adapter family allows this configuration). A task change event is sent to the portlet application.

At (401), the application-related worklet normalizes the task state change event and pass it to the integrated worklist portlet application. The worklet is in charge of adapting the application-specific data representation of the task change event to the normalized data representation of task change event within the integrated worklist data model. The normalized event is then passed to the integrated worklist portlet application

At (402), the integrated worklist portlet updates its internal integrated worklist data model. For example, a task change event carrying a state change from “New” to “In Progress” will cause an update of the task state from “New” to “In Progress” within the data model.

At (403), the integrated worklist portlet updates its portlet view. A standard software design pattern such as Model-View-Controller describes how to implement this model/view update.

At (404), the integrated worklist portlet application triggers registered notification services. The support for an integrated worklist as described can connect with a notification service such as the Intelligent Notification Services component part of IBM WebSphere Everyplace Access 5.1. The notification service will poll the users upon a task status changes using an asynchronous technology such as e-mail or SMS (Short Message Services).

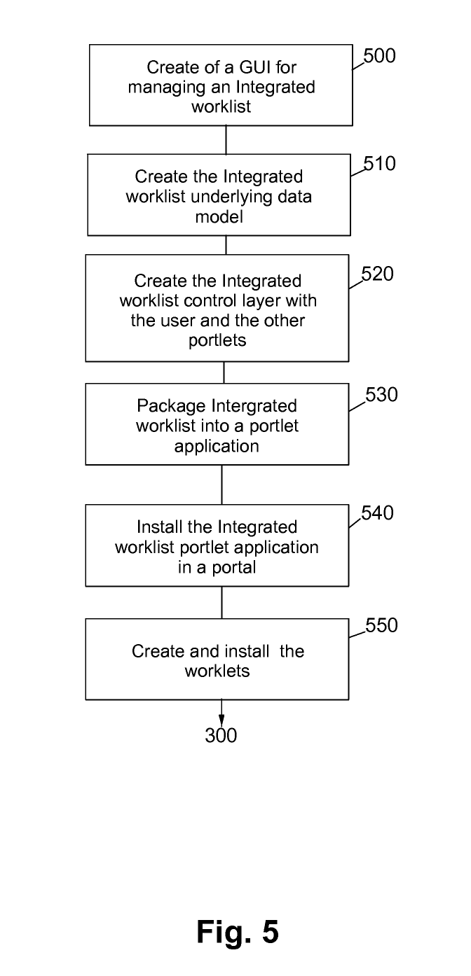

FIG. 5 is a flowchart describing the creation of the environment for managing an Integrated worklist on a portal according to an embodiment of the present invention. The developer creates (500) a Graphical User Interface (GUI) displaying for the portal user the integrated worklist of the tasks assigned to the user. The view which is accessed through the web browser on the client side of the portal is described above in the document in relation with FIG. 2.

The developer creates (510) the integrated worklist underlying data model which describes the structure of the worklist state and content used during a user session. The data model comprises all the work items and user preferences. The data model content will be stored in a database included in the Integrated portlet application context.

The developer creates (520) the integrated worklist control layer code which controls the interactions with the GUI and the interactions with other application portlets.

The portal administrator installs (540) the integrated worklist portlet application code in a portal on which are installed the portlet applications having a worklist to be managed. The integrated worklist portlet application is ready to receive logging of a user to the portal (300).

The integrated worklist application can be developed in Java, which is a prerequisite for support of JSR168 (Java and J2EE are trademarks of Sun Microsystems, Inc.) and J2EE which are standards to develop an application in context of a portal. The integrated worklist data model is persisted with a product such as IBM DB2. The IBM Cloudscape database (DB2 and Cloudscape are trademarks of International Business Machines Corporation in certain countries) could be advantageously used in this context because Cloudscape can be embedded within the integrated worklist portlet application code (no need to deploy and maintain a specific database instance for the Integrated worklist data model). Moreover, IBM Cloudscape does not require any administration.

The foregoing description of the embodiments of this invention has been presented for purposes of illustration and description. It is not intended to be exhaustive or to limit the invention to the precise form disclosed, and many modifications and variations are possible.

What is claimed is:

1. A method for managing from a portal, worklists of more than one server application, each of the server applications owning one of the worklists and having at least one portlet on the portal, comprising:
a portal user connects to the portal with an identifier;
a worklist portlet for each server application reads the user identifier and displays to the user a corresponding user worklist content and preferences to an integrated worklist portlet;
the integrated worklist portlet, using a graphical user interface, reads the user worklist content and preferences for each server application and builds and displays to the user a view of an integrated worklist integrating the worklists of all the server applications.

2. The method of claim 1, further comprising:
the user selects in the view of the integrated worklist one representation of a task;
the integrated worklist portlet communicates this task selection to a server application portlet owning the worklist to which the selected task belongs;
the server application portlet owning the worklist communicates with the corresponding server application, using a graphical user interface, builds and displays to the user a view of this task allowing the user to work on this task.

3. The method of claim 1, further comprising:
a state change of a task in the server application is detected by the server application worklist portlet;
the server application worklist portlet creates data of an event for the task change understandable by the integrated worklist portlet and sends task change event data to the integrated worklist portlet; and
the integrated worklist portlet updates the view of the integrated worklist and display it to the portal user.

4. The method of claim 3, wherein the integrated worklist portlet triggers registered notification services.

5. The method of claim 1, further comprising:
a new server application portlet is deployed on the portal;
a new corresponding server application worklist portlet is deployed on the portal, the new server application worklist portlet storing a list of user identifiers associated with corresponding user worklist content and preferences; and
the new server application worklist portlet waits for a next portal user connection.

6. The method of claim 1, further comprising JSR168 compliant portlets and portal.

7. The method of claim 6, further comprising:
moving the integrated worklist portlet application to any other JSR168 compliant portal comprising other JSR168 compliant portlets;
adding a new server application worklist portlet going along with each server application portlet; and
re-deploying the server application portlets including the new worklist portlets.

8. A computer program product comprising programming code instructions for executing the method of claim 1 when executed on a computer.

9. A system comprising means adapted for carrying out the method according to claims 1.
